(19) United States
(12) Patent Application Publication
(10) Pub. No.: US 2024/0270921 A1
(43) Pub. Date: Aug. 15, 2024

(54) METHOD FOR PREPARING MELAMINE RESIN FOAMS USING GRINDED MELAMINE FOAM PARTICLES

(71) Applicant: BASF SE, Ludwigshafen am Rhein (DE)

(72) Inventors: Alexander KOENIG, Ludwigshafen am Rhein (DE); Bernhard VATH, Ludwigshafen am Rhein (DE); Kai Oliver SIEGENTHALER, Ludwigshafen am Rhein (DE); Tobias Heinz STEINKE, Ludwigshafen am Rhein (DE)

(21) Appl. No.: 18/569,717

(22) PCT Filed: Jun. 7, 2022
(86) PCT No.: PCT/EP2022/065386

§ 371 Date: Dec. 13, 2023

(30) Foreign Application Priority Data
Jun. 17, 2021 (EP) 21179922.6

(51) Int. Cl. C08J 9/35; C08J 3/12; C08J 3/28; C08J 9/14; C08J 9/16; C08J 9/236; C08J 11/06

(52) U.S. Cl. CPC C08J 9/35; C08J 3/12; C08J 3/28; C08J 9/141; C08J 9/16; C08J 9/236; C08J 11/06; C08J 2203/14

(57) ABSTRACT

The present invention provides a process for producing a melamine resin foam comprising heating and foaming an aqueous mixture M using microwave radiation, said mixture M comprising melamine resin foam particles, at least one melamine-formaldehyde precondensate, at least one curative, at least one surfactant and at least one blowing agent as well as a process for recycling melamine resin foam scrap.

The present invention relates to a method for preparing melamine resin foams using grinded melamine foam particles as well as to a melamine resin foam obtainable by this method. In particular, the present invention relates to a method for recycling melamine resin foam scrap.

### RELEVANT PRIOR ART

WO 2010/039574 relates to a liquid hard surface cleaning composition comprising melamine foam fibres and a formaldehyde scavenger.

CN 103030924 A discloses fiber material modified melamine formaldehyde foam with improved mechanical properties, such as flexibility and compression strength. The fibrous material, such as glass fibers, polyester fibers, polyamide fibers, carbon fibers or cotton fibers, is added in amounts of 0.2-10 wt. % of the formaldehyde solution and the melamine before polymerization of the resin solution.

DE 10 2007 009 127 A1 relates to an open-cell foam based on an amino resin comprising 0.5 to 50 weight % of a fibrous filler such as melamine fibers to increase the mechanical properties, especially the compressive strength of open-cell foams.

WO 2011/061178 relates to melamine resin foam with improved sound-absorbent and sound-deadening properties in the frequency range from about 300 to 1600 Hz, comprising from 40 to 85% by weight of open-cell polymer foam and from 15 to 60% by weight of hollow microbeads with flexible external layer, where the D50 value of the hollow microbeads is at least 70 μm and at most 250 μm, based on the total weight of polymer foam and hollow microbeads. The melamine resin foam is impregnated with a liquid dispersion comprising expandable hollow microbeads.

WO 2009/021963 relates to a method for the production of an abrasive foam on the basis of a melamine-formaldehyde-condensation product comprising inorganic nanoparticles, with the following steps: (1) Producing a solution or dispersion comprising a precondensate of the foam to be produced and inorganic nanoparticles, (2) foaming the precondensate by heating the solution or dispersion from step (1), in order to obtain a foam comprising inorganic nanoparticles, and if applicable (3) tempering the foam obtained in step (2), which leads to an increased abrasion when polishing delicate surfaces.

U.S. Pat. No. 8,937,106 B2 relate to open-celled foams filled with nanoporous particles, especially aerogels or aerosils with improved thermal conductivity and acoustical absorption. In a first embodiment the melamine resin foam is impregnated with the nanoporous, preferably inorganic particles. In the second embodiment, the nanoporous granular particles are mixed with the melamine-formaldehyde precondensate before foaming.

CN 112 795 053 A discloses a method for recycling melamine formaldehyde resin waste and preparation of a flame retardant therefrom.

EP 2 703 074 A1 disclose a method for producing a melamine resin foam with an improved combination of mechanical and acoustical properties and producing shaped articles.

The object of the present invention is to provide a method for recycling melamine resin foam scrap. Especially the melamine foam scrap should be recycled to produce melamine resin foams with improved cleaning behavior and acoustic absorption at low density.

To solve the problem, the present invention provides a process for producing a melamine resin foam comprising heating and foaming an aqueous mixture M using microwave radiation, said mixture M comprising melamine resin foam particles, at least one melamine-formaldehyde precondensate, at least one curative, at least one surfactant and at least one blowing agent.

The melamine foam particles may be obtained by milling the melamine resin foam scrap. Preferably the melamine foam particles are milled in a 2-step process. In the first step melamine resin foam blocks are milled to foam flakes. The largest dimension of the foam flakes is preferably in the range from 2-5 cm. In a second step the foam flakes are further milled to foam particles. The mean particle size of the foam particles is preferably in the range form 1-250 μm.

In a preferred embodiment, the melamine-resin foam particles have a mean particle size in the range from 1-250 μm; more preferably 10 to 200 μm.; and most preferably 25-150 μm. The mean particle size may be determined as particle size distribution with a D₁₀, D₅₀ and D₉₀ value, number averaged, determined via optical or electron microscopy combined with image analysis or sieving. Sieving may be done using an air jet sieve. Preferably, the D₉₀ number of total distribution of the melamine resin particles size is below 150 μm, more preferably below 125 μm, most preferably between 50 μm and 110 μm, determined by light microscope. 90% of particles have diameters below the D₉₀ value. 50% of particles have diameters smaller and 50% have diameters larger than the median diameter D₅₀.

In a preferred embodiment, the melamine resin foam particles have a bulk density in the range from 10-500 kg/m³; more preferably 15-250 kg/m³; and most preferably 20-150 kg/m³.

In a preferred embodiment, the weight ratio of melamine resin foam particles to melamine-formaldehyde precondensate is in the range from 0.01/100 to 50/100; more preferably in the range from 0.1/100 to 25/100; and most preferably in the range from 0.5/100 to 10/100.

The density of the melamine resin foam prepared according to the process of the invention is preferably in the range from 5 to 30 kg/m³, more preferably in the range from 8 to 20 kg/m³.

The melamine foam can be produced as described in WO 2009/021963. Preferably The melamine resin foam particles are pre-mixed with at least one melamine resin in form of a powder or in aqueous solution. To this melamine resin premix at least one curative, at least one surfactant and at least one blowing agent is added to form an aqueous mixture M. The melamine resin foam is obtained by heating and foaming the aqueous mixture M using microwave radiation. The melamine resin foam can be tempered at a temperature between 120-300° C.

The melamine/formaldehyde precondensates may be prepared separately or commercially available precondensates of the two components, melamine and formaldehyde may be used. Preferably a melamine-formaldehyde precondensate having a molar ratio of melamine to formaldehyde ranging from 5:1 to 1.3:1, more preferably from 3.5:1 to 1.5 to 1 is used. Preferably the number average molecular weight Mn ranges from 200 g/mol to 1000 g/mol. Preference is given to unmodified melamine/formaldehyde precondensates.

Anionic, cationic and nonionic surfactants and also mixtures thereof can be used as dispersant/emulsifier.

Useful anionic surfactants include for example diphenylene oxide sulfonates, alkane and alkylbenzenesulfonates, alkylnaphthalenesulfonates, olefinsulfonates, alkyl ether sulfonates, fatty alcohol sulfates, ether sulfates, α-sulfo fatty acid esters, acylaminoalkanesulfonates, acyl isethionates, alkyl ether carboxylates, N-acylsarcosinates, alkyl and alkylether phosphates. Useful nonionic surfactants include alkylphenol polyglycol ethers, fatty alcohol polyglycol ethers, fatty acid polyglycol ethers, fatty acid alkanolamides, ethylene oxide-propylene oxide block copolymers, amine oxides, glycerol fatty acid esters, sorbitan esters and alkylpolyglycosides. Useful cationic emulsifiers include for example alkyltriammonium salts, alkylbenzyldimethylammonium salts and alkylpyridinium salts.

The dispersants/emulsifiers can be added in amounts from 0.2% to 5% by weight, based on the melamine-formaldehyde precondensate.

Preferably the mixture M comprises a surfactant mixture comprising a mixture of 50 to 90 wt % of at least one anionic surfactant and 10 to 50 wt % of at least one nonionic surfactant, wherein the weight percentages are each based on the total weight of the surfactant mixture.

As curatives it is possible to use acidic compounds which catalyze the further condensation of the melamine resin. The amount of these curatives is generally in the range from 0.01% to 20% by weight and preferably in the range from 0.05% to 5% by weight, all based on the precondensate. Useful acidic compounds include organic and inorganic acids, for example selected from the group consisting of hydrochloric acid, sulfuric acid, phosphoric acid, nitric acid, formic acid, acetic acid, oxalic acid, toluene sulfonic acids, amido sulfonic acids, acid anhydrides and mixtures thereof. Preferably formic acid is used as curative.

The mixture further comprises at least one blowing agent. Useful physical blowing agents include for example hydrocarbons, such as pentane, hexane, halogenated, more particularly chlorinated and/or fluorinated, hydrocarbons, for example methylene chloride, chloroform, trichloroethane, chlorofluorocarbons, hydrochlorofluorocarbons (HCFCs), alcohols, for example methanol, ethanol, n propanol or isopropanol, ethers, ketones and esters, for example methyl formate, ethyl formate, methyl acetate or ethyl acetate, in liquid form or air, nitrogen or carbon dioxide as gases.

The amount of blowing agent in the mixture generally depends on the desired density for the foam. Preferably the amount in relation to the melamine-formaldehyde precondensate is chosen in an amount that the density of the foam is 5 to 15 kg/m³, more preferably 6 to 12 kg/m³. The blowing agent is preferably present in the mixture in an amount of 0.5% to 60% by weight, preferably 1% to 40% by weight and more preferably 1.5% to 30% by weight, based on the melamine-formaldehyde precondensate. It is preferable to add a physical blowing agent having a boiling point between 0 and 80° C. Most preferably pentane is used as blowing agent.

The precondensate being foamed up generally by heating the suspension of the melamine-formaldehyde precondensate to obtain a foamed material.

The introduction of energy may preferably be effected via electromagnetic radiation, for example via high-frequency radiation at 5 to 400 KW, preferably 5 to 200 KW and more preferably 9 to 120 KW per kilogram of the mixture used in a frequency range from 0.2 to 100 GHZ, preferably 0.5 to 10 GHz. Magnetrons are a useful source of dielectric radiation, and one magnetron can be used or two or more magnetrons at the same time.

The foamed materials produced can be finally dried, removing residual water and blowing agent from the foam. Drying is carried out preferably in a drying oven at a temperature in the range of 40 to 200° C., particularly preferably 100 to 150° C. until a constant weight. The process described provides blocks or slabs of foamed material, which can be cut to size in any desired shapes.

Preferably the process is used for recycling melamine resin foam scrap, preferably from melamine resin foam from the production plant, which was produced with properties outside the desired specification. A further subject to the present invention is a process for recycling melamine resin foam comprising the steps:
a) milling melamine resin foam scrap to foam flakes with a largest dimension in the range from 2-5 cm,
b) milling the foam flakes from step a) to foam particles having a particle size distribution with a D₉₀ value below 150 μm, determined by light microscope or sieving,
c) forming an aqueous mixture M from the foam particles from step b), at least one melamine-formaldehyde precondensate, at least one curative, at least one surfactant and at least one blowing agent,
d) heating and foaming the aqueous mixture M using microwave radiation to produce a melamine resin foam, and
e) optionally tempering the melamine resin foam obtained in step d) at a temperature between 120-300° C.

A further subject of the present invention is a melamine resin foam obtainable according to the process of the invention. The melamine resin foam particles are homogeneously distributed through the melamine foam.

The melamine resin foam prepared by the method according to the invention may be post-treated by the following methods:
1. Thermocompression to obtain foams with higher density, better durability and cleaning behavior.
2. Hydrophobation to obtain foams with lower water uptake and
3. Impregnation of flame retardants to improve the FST properties (Flame, Smoke, toxicity) in the case of fire.

A process for producing resilient compressed foamed materials having anisotropic mechanical properties on the basis of melamine-formaldehyde resins comprising a step of compressing the soft, uncured melamine-formaldehyde foamed material and curing and drying the foamed material obtained is described in WO 2011/134778.

Hydrophilization by impregnation with a fluorocarbon resin and/or silicon resin and impregnation with flame-retardant substances, such as silicates, borate, hydroxides or phosphates can be achieved as described in WO 2007/023118.

Preferably the density of the melamine resin foam is in the range from 5 to 15 kg/m³, more preferably 6 to 12 kg/m³.

The melamine resin foam of the melamine resin foam produced according to the invention can be used for acoustic and/or thermal insulation or for cleaning, grinding or polishing sponges.

### BRIEF DESCRIPTION OF DRAWINGS

FIG. 1 is a microscope picture of a melamine resin foam according to the invention

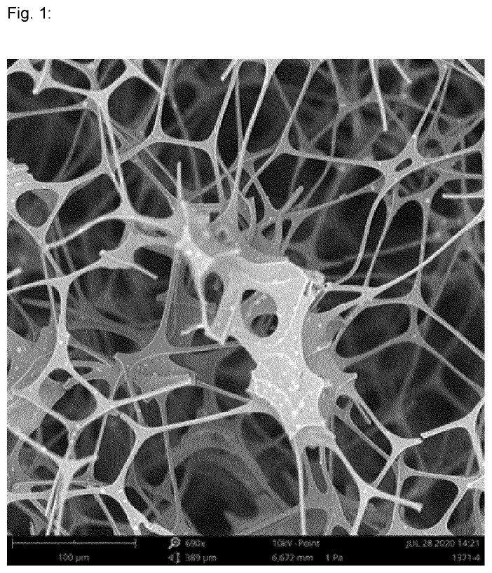

Particles are fragments of the former cellular strut network and show the respective shape (struts and nods)—In the foaming process the particles get wetted by the MF resin and can build up porous or compact substructures (REM pictures).

### Embodiments

the present invention includes the following embodiments, wherein these include the specific combinations of embodiments
1. A process for producing a melamine resin foam comprising heating and foaming an aqueous mixture M using microwave radiation, said mixture M comprising melamine resin foam particles, at least one melamine-formaldehyde precondensate, at least one curative, at least one surfactant and at least one blowing agent.
2. The process according to embodiment 1, wherein the melamine-resin foam particles having a particle size distribution with a D₉₀ value below 150 μm, determined by microcopy.
3. The process according to embodiment 1 or 2, wherein the melamine resin foam particles have a bulk density in the range from 10-500 kg/m³.
4. The process according to embodiment any of embodiments 1 to 3, wherein the weight ratio of melamine resin foam particles to melamine-formaldehyde precondensate is in the range from 1/100 to 10/100.
5. The process according to any of embodiments 1 to 4, wherein said mixture M comprises a surfactant mixture comprising a mixture of 50 to 90 wt.-% of at least one anionic surfactant and 10 to 50 wt.-% of at least one nonionic surfactant, wherein the weight percentages are each based on the total weight of the surfactant mixture.
6. The process according to any of embodiments 1 to 5 wherein formic acid is used as curative.
7. The process according to any of embodiments 1 to 6 wherein pentane is used as blowing agent.
8. A process for recycling melamine resin foam, wherein milled melamine resin foam scrap is used as melamine resin foam particles in the process according to embodiment 1.
9 The process according to any of embodiments 1 to 8, wherein the density of the melamine resin foam is in the range from 5 to 30 kg/m³.
8. A process for recycling melamine resin foam comprising the steps:
   a) milling melamine resin foam scrap to foam flakes with a largest dimension in the range from 2-5 cm,
   b) milling the foam flakes from step a) to foam particles having a particle size distribution with a D₉₀ value below 150 μm,
   c) forming an aqueous mixture M from the foam particles from step b), at least one melamine-formaldehyde precondensate, at least one curative, at least one surfactant and at least one blowing agent,
   d) heating and foaming the aqueous mixture M using microwave radiation to produce a melamine resin foam, and
   e) optionally tempering the melamine resin foam obtained in step d) at a temperature between 120-300° C.
9. A melamine resin foam obtainable by the process of any of embodiments 1 to 9.
10. Use of the melamine resin foam according to embodiment 9 for acoustic and/or thermal insulation or for cleaning, grinding or polishing sponges.

### EXAMPLES

Hereinafter, the present invention is described in more detail and specifically with reference to the Examples, which however are not intended to limit the present invention.

### Methods of Measurement:

### Ram Pressure Value [N]:

Ram pressure measurements for evaluating the mechanical quality of the melamine resin foams were all carried out as follows. A cylindrical ram having a diameter of 8 mm and a height of 10 cm was pressed into a cylindrical sample having a diameter of 11 cm and a height of 5 cm in the direction of foaming at an angle of 90% until the sample tore. The tearing force [N], hereinafter also referred to as ram pressure value, provides information as to the quality of the foam.

### Cleaning Test:

The lipid emulsion consists of a mixture of 6 g Physioderm Crème 100, Physioderm and 0.2 g Active Char (Aktivkohle, gekörnt, reinst 1.5 mm), Merck in 100 mL 2-Propanole is applied in ˜80 mm stripes on a ceramic tile with a film thickness of ˜400 μm and dried at 160° C. for 15 minutes. The melamine-resin foam specimen (geometry: 140 mm×80 mm×30 mm) were put under water for 10 s and subsequently squeezed out by hand. Evaluation criteria: How many manual hubs (up+down=1 hub) of the wet foam specimen are necessary to remove a width of 2 cm of the dirt film coating. The less hubs are needed the better the cleaning efficacy.

### Acoustic Absorbance

Acoustic absorbance was measures according to ISO 10534-2 with an impedance tube and melamine-resin foam samples with 30 mm thickness 100. mm diameter. The absorption value at 1250 Hz is given (value of 1.000=100% of absorption)

### Materials Used:

MF Melamine-formaldehyde precondensate having an average molecular weight (number average) M of 350 g/mol, with a molar ratio of melamine:formaldehyde of 1:3, which apart from melamine comprised no further thermoset-formers and apart from formaldehyde comprised no further aldehydes and which was sulfite group free.
T1 C₁₂/C₁₄-alkyl sulfate, sodium salt.
T2 alkyl polyethylene glycol ether made from a linear, saturated C₁₆/C₁₈ fatty alcohol.
MF-P Milled melamine-formaldehyde foam particles (mean particle size 60-120 μm, bulk density 27 g/L))
   Determination of Particle Size Distribution: Particle size distribution was measured by light microscope measurements using of Olympus

BX 60. For every sample 100 individual particles were measured. The resulting data was calculated as number total distribution D10, D50 and D90. 90% of particles have diameters below the D90 value. 50% of particles have diameters smaller and 50% have diameters larger than the median diameter D50.

Particle size distribution was measured by an air jet sieve ALPINE Luftstrahlsieb® 200 LS-N with the following conditions:
Sample Weight: 10 g
Sieves: 125, 90 and 60 μm
Vacuum (under the sieves): 40 mbar
Air Flow Velocity: 50 m3/h

### Preparation of Melamine-Formaldehyde Foam Particles MF-P1:

A melamine-formaldehyde foam block (Basotect®) was comminuted to foam flakes (10-100 mm) in laboratory scale with a cutting mill Pallmann PS 3.5 and sieved through square wholes of 15 mm. The flakes were further cut with a cutting mill Retsch SM 2000 and sieved by gravitation through a Condidur sieve 1 mm. The throughput was 1.4 kg per hour. The particle size was between 60-100 μm determined by microscope. The particle size distribution determined by air jet sieve is summarized in Table 1.

### Preparation of Melamine-Formaldehyde Foam Particles MF-P2:

A melamine-formaldehyde foam block (Basotect®) was comminuted to foam flakes (10-100 mm) with a cutting mill Pallmann PS 3.5 and sieved through square wholes of 15 mm. The flakes were manually dosed and further cut in production scale with a cutting mill Netzsch, SecoMy 37 (rotary speed: 1072 min-1, engine output 37 KW) and sieved through a 315 m sieve. The throughput was 300 kg per hour. The particle size was between 40-60 μm determined by microscope. The particle size distribution determined by microscope and air jet sieve is summarized in Table 1 and 2. Bulk density was 97 kg/m³ (+/−2.5 kg/m³) at humidity 8% (+/−1%).

### Preparation of Melamine-Formaldehyde Foam Particles MF-P3:

A melamine-formaldehyde foam block (Basotect®) was comminuted to foam flakes (10-100 mm) with a cutting mill Pallmann PS 3.5 and sieved through square wholes of 15 mm. The flakes were manually dosed and further cut in production scale with a cutting mill Netzsch, SecoMy 50 S (Air classifier at 3000 min-1, rotary speed: 1072 min-1, engine output 37 KW) and sieved through a 315 m sieve. The throughput was 160 kg per hour. The particle size distribution determined by microscope and air jet sieve is summarized in Table 1 and 2.

TABLE 1
Particle size distribution of MF-P1 to
MF-P3 by light microscope

| Number sum | Particle | Particle | Particle |
|---|---|---|---|
| distribution | size [μm] | size [μm] | size [μm] |
| Sample | MF-P1 | MF-P2 | MF-P3 |
| D₁₀ | 41.9 | 21.5 | 24.9 |
| D₅₀ | 69.3 | 50.8 | 46.0 |
| D₉₀ | 103.6 | 82.3 | 74.8 |

TABLE 2
Particle size distribution of MF-P1 to MF-P3 by air jet sieve

| Sample | MF-P1 | MF-P2 | MF-P3 |
|---|---|---|---|
| Particle size | Residue [%] | Residue [%] | Residue [%] |
| >125 μm | 3.6 | 1.4 | 0.1 |
| >90-125 μm | 14.2 | 5.8 | 2.3 |
| 60-90 μm | 60.8 | 20.2 | 22.3 |
| <60 μm | 21.4 | 72.6 | 75.3 |

### Comparative Example C1

In a first step, 100 parts by weight of the melamine-formaldehyde precondensate, MF, 38 parts by weight of water, 1.2 parts by weight of anionic surfactant T1, 0.3 parts by weight of non-ionic surfactant T2, 2.5 parts of sodium formate, 3.0 parts of formic acid and 19.5 parts by weight of the pentane were mixed with one another at a temperature of 20 to 35° C. The mixture was introduced into a foaming mold of polypropylene and irradiated in a microwave oven with microwave. The foam bodies obtained after microwave irradiation were annealed in a circulating air oven at 200° C. for 20 min. The density of the foam was 10.2 g/L and Ram pressure value was 28.0 N.

### Comparative Example C2

In a first step, 100 parts by weight of the melamine-formaldehyde precondensate, MF, 38 parts by weight of water, 1.2 parts by weight of anionic surfactant T1, 0.3 parts by weight of non-ionic surfactant T2, 2.5 parts of sodium formate, 3.0 parts of formic acid and 17.8 parts by weight of the pentane were mixed with one another at a temperature of 20 to 35° C. The mixture was introduced into a foaming mold of polypropylene and irradiated in a microwave oven with microwave. The foam bodies obtained after microwave irradiation were annealed in a circulating air oven at 200° C. for 20 min. The density of the foam was 8.6 g/L and Ram pressure value was 24.9 N.

### Examples 1-4

In a first step, 100 parts by weight of the melamine-formaldehyde precondensate, MF, 2.5-10 parts per weight of melamine-formaldehyde foam particles MF-P1 (amount according to Table 3), 38 parts by weight of water, 1.2 parts by weight of anionic surfactant T1, 0.3 parts by weight of non-ionic surfactant T2, 2.5 parts of sodium formate, 3.0 parts of formic acid and 19.5 parts by weight of the pentane were mixed with one another at a temperature of 20 to 35° C. The mixture was introduced into a foaming mold of polypropylene and irradiated in a microwave oven with microwave. The foam bodies obtained after microwave irradiation were annealed in a circulating air oven at 200° C. for 20 min. The density of the foam was around 10 g/L and Ram pressure value was between 20 and 25 N (see Table 3).

TABLE 3
Amount of recycled MF-P1 form particles and properties of
MF foams of Comparative Examples C1, C2 and Examples 1-4

| Example | C1 | C2 | 1 | 2 | 3 | 4 |
|---|---|---|---|---|---|---|
| MF-P1 [parts added | | | 2.5 | 5.0 | 7.5 | 10.0 |
| per 100 parts of MF | | | | | | |
| precondensate] | | | | | | |
| Density [kg/m³] | 8.6 | 10.2 | 10.1 | 9.9 | 10.2 | 10.2 |
| RAM pressure value | 24.9 | 28.0 | 24.2 | 23.5 | 22.9 | 20.2 |
| [N] | | | | | | |
| Cleaning efficiency | 5 | 5 | 4 | 3 | 3 | 3 |
| [manual hubs] | | | | | | |
| Acoustic absorbance | 0.56 | 0.56 | 0.57 | 0.60 | 0.67 | Not |
| value at 1250 Hz, | | | | | | determined |
| sample thickness | | | | | | |
| 30 mm | | | | | | |

### Examples 5-8

Examples 1˜4 were repeated using melamine-formaldehyde foam particles MF-P2. Amount of MP-P2 added per 100 parts of MF precondensate and properties of the foams obtained are summarized in Table 4.

TABLE 4
Amount of recycled MF-P2 form particles and
properties of MF foams of Examples 5-8

| Example | 5 | 6 | 7 | 8 |
|---|---|---|---|---|
| MF-P2 [parts added | 2.5 | 5.0 | 7.5 | 10.0 |
| per 100 parts of MF | | | | |
| precondensate] | | | | |
| Density [kg/m³] | 9.3 | 10.2 | 9.9 | 10.5 |
| RAM pressure value | 24 | 21 | 21 | 19 |
| [N] | | | | |
| Cleaning efficiency | 3 | 3 | 3 | 3 |
| [manual hubs] | | | | |
| Acoustic absorbance | 0.62 | 0.62 | 0.62 | Not |
| value at 1250 Hz, | | | | determined |
| sample thickness 30 | | | | |
| mm | | | | |

### Examples 9-12

Examples 1˜4 were repeated using melamine-formaldehyde foam particles MF-P3. Amount of MP-P2 added per 100 parts of MF precondensate and properties of the foams obtained are summarized in Table 5.

TABLE 5
Amount of recycled MF-P3 form particles and
properties of MF foams of Examples 9-12

| Example | 9 | 10 | 11 | 12 |
|---|---|---|---|---|
| MF-P3 [parts added | 2.5 | 5.0 | 7.5 | 10.0 |
| per 100 parts of MF | | | | |
| precondensate] | | | | |
| Density [kg/m³] | 9.0 | 9.9 | 9.6 | 10.3 |
| RAM pressure value | 28 | 26 | 23 | 18 |
| [N] | | | | |
| Cleaning efficiency | 4 | 3 | 3 | 3 |
| [manual hubs] | | | | |
| Acoustic absorbance | 0.62 | 0.66 | 0.66 | Not |
| value at 1250 Hz, | | | | determined |
| sample thickness 30 | | | | |
| mm | | | | |

1.-12. (canceled)

13. A process for producing a melamine resin foam with a density in the range from 5 to 30 kg/m³ comprising heating and foaming an aqueous mixture M using microwave radiation, said mixture M comprising melamine resin foam particles, at least one melamine-formaldehyde precondensate, at least one curative, at least one surfactant and at least one blowing agent.

14. The process according to claim 13, wherein the melamine-resin foam particles have a particle size distribution with a D₉₀ value below 150 μm, determined by microcopy.

15. The process according to claim 13, wherein the melamine resin foam particles have a bulk density in the range from 10-500 kg/m³.

16. The process according to claim 13, wherein the weight ratio of melamine resin foam particles to melamine-formaldehyde precondensate is in the range from 0.5/100 to 10/100.

17. The process according to claim 13, wherein said mixture M comprises a surfactant mixture comprising a mixture of 50 to 90 wt.-% of at least one anionic surfactant and 10 to 50 wt.-% of at least one nonionic surfactant, wherein the weight percentages are each based on the total weight of the surfactant mixture.

18. The process according to claim 13 wherein formic acid is used as curative.

19. The process according to claim 13 wherein pentane is used as blowing agent.

20. A process for recycling melamine resin foam, wherein milled melamine resin foam scrap is used as melamine resin foam particles in the process according to claim 13.

21. A process according to claim 13, wherein the density of the melamine resin foam is in the range from 8 to 20 kg/m³.

22. A process for recycling melamine resin foam comprising the steps:
a) milling melamine resin foam scrap to foam flakes with a largest dimension in the range from 2-5 cm,
b) milling the foam flakes from step a) to foam particles having a particle size distribution with a D₉₀ value below 150 μm, determined by light microscope or sieving,
c) forming an aqueous mixture M from the foam particles from step b), at least one melamine-formaldehyde precondensate, at least one curative, at least one surfactant and at least one blowing agent,
d) heating and foaming the aqueous mixture M using microwave radiation to produce a melamine resin foam, and
e) optionally tempering the melamine resin foam obtained in step d) at a temperature between 120-300° C.

23. A melamine resin foam obtained by the process of claim 13.

24. A method comprising utilizing the melamine resin foam according to claim 23 for acoustic and/or thermal insulation or for cleaning, grinding or polishing sponges.
